(19) United States
(12) Patent Application Publication
(10) Pub. No.: US 2016/0016461 A1
(43) Pub. Date: Jan. 21, 2016

(54) Adjustment Device, Method of Adjustment, Motor Vehicle

(71) Applicant: MCI (MIRROR CONTROLS INTERNATIONAL) NETHERLANDS B.V., Woerden (NL)

(72) Inventors: Erik Alfred Simeon de Vries, Woerden (NL); Stefan Frits Brouwer, Woerden (NL); Stephen Alexander George Gustavo Boom, Woerden (NL); Bastiaan Huijzers, Woerden (NL)

(21) Appl. No.: 14/772,318

(22) PCT Filed: Mar. 11, 2014
(86) PCT No.: PCT/NL2014/050145

§ 371 Date: Sep. 2, 2015

(30) Foreign Application Priority Data
Mar. 11, 2013 (NL) 2010428

(51) Int. Cl. B60K 11/08; H02K 7/116; F16H 19/08

(52) U.S. Cl. CPC B60K 11/085; F16H 19/08; H02K 7/116

(57) ABSTRACT

Adjustment device for adjusting shutoff elements of an air inlet of a motor vehicle, wherein the shutoff elements are adjustable between an open position in which the air inlet is substantially open and a closed position in which the air inlet is substantially closed, includes a drive unit for adjusting the shutoff elements between at least the open position and the closed position, and a fail-safe mechanism which is arranged for adjusting the air inlet to a predefined position in case of a calamity situation. The adjustment device includes a blocking mechanism for blocking the operation of the fail-safe mechanism in predetermined situations, wherein in such predetermined situations the shutoff elements are adjustable to a predefined position without activation of the fail-safe mechanism.

This application is a 35 U.S.C. §371 national phase application of PCT/NL2014/050145 (WO 2014/163488), filed on Mar. 11, 2014, entitled “Adjustment Device, Method of Adjustment, Motor Vehicle”, which application claims priority to Netherlands Application No. 2010428, filed Mar. 11, 2013, each of which is incorporated herein by reference in its entirety.

The invention relates to an adjustment device for adjusting shutoff elements of an air inlet of a motor vehicle.

Such adjustment devices are known. For instance, publications WO 2012/067502 or WO 2013/012337 describe an adjustment device. The shutoff elements are usually adjustable between an open position in which the air inlet is substantially open and a closed position in which the air inlet is substantially closed and/or in a random position between the open and the closed position. To this end, the adjustment device is provided with a drive unit for adjusting the shutoff elements. The shutoff elements can be, for instance, strips which are pivotable about a standing or a lying axis, or may be, for instance, roller curtains, or may be, for instance, flower-shaped strips, etc. Many variants for shutoff elements are possible.

It is also known to design an adjustment device with a fail-safe mechanism to adjust the shutoff elements of the air inlet to a predefined position in the event of a calamity. A calamity can be, for instance, a malfunction in the drive unit of the adjustment device and/or a circumstance in the motor vehicle, or outside of it, that can make it desirable to open or close the air inlet quickly, for instance, in case of fire in the motor compartment, or in case of increased concentration of sand or dust in the ambient air. A calamity where a fail-safe mechanism could intervene is in the case of a power failure. If a calamity occurs, the fail-safe mechanism will come into operation and the shutoff elements will be adjusted to the predefined position. If, for instance, the air inlet is closed and, as a result of power failure, the adjustment device is no longer able to open the air inlet, this can have damaging consequences for the engine due to the rising temperature in the motor compartment. In such a calamity, the fail-safe mechanism can come into operation to bring the shutoff elements, for instance, to a predefined open position.

A disadvantage of a fail-safe mechanism, however, is that for instance upon parking the motor vehicle, the fail-safe mechanism comes into operation and the shutoff elements are brought to the predefined position. This is because upon parking the motor vehicle, the current supply to the adjusting instrument is cut off. Interruption of the current supply is normally recognized as a calamity situation. Depending on which position is the predefined position, i.e., the open position or the closed position or an intermediate position, this may be esthetically undesirable and/or this may lead to unwanted cooling down of the engine, etc.

Accordingly, there is a need for an adjusting instrument that counteracts at least the above-mentioned disadvantage, while preserving the advantages of a fail-safe mechanism.

To that end, an aspect of the invention provides an adjustment device for adjusting shutoff elements of an air inlet of a motor vehicle, wherein the shutoff elements are adjustable between an open position in which the air inlet is substantially open and a closed position in which the air inlet is substantially closed, comprising a drive unit for adjusting the shutoff elements between at least the open position and the closed position, furthermore comprising a fail-safe mechanism arranged for adjusting the air inlet to a predefined position in case of a calamity situation, wherein the adjustment device furthermore comprises a blocking mechanism for blocking the operation of the fail-safe mechanism in predetermined situations, wherein in such predetermined situations at least a part of the shutoff elements are adjustable to a predefined position without activation of the fail-safe mechanism.

By providing a blocking mechanism which blocks the operation of the fail-safe mechanism in predetermined situations, the fail-safe mechanism can come into operation in a calamity situation, whereas in predetermined non-calamity situations the operation of the fail-safe mechanism is blocked, the fail-safe mechanism can then be temporarily rendered inoperative.

Upon rendering the fail-safe mechanism temporarily inoperative, at least a part of the shutoff elements can be adjusted to a predetermined position. For instance, an upper part and/or a lower part and/or a central part of the shutoff elements may be adjusted, or a left part and/or a right part of the shutoff elements may be adjusted. Also, for instance, two or more sets of shutoff elements may be provided, while, for instance, at least one set is still adjustable when the fail-safe mechanism has been rendered temporarily inoperative.

For instance upon parking of the motor vehicle, the engine of the motor vehicle is switched off and the current supply to the adjustment device is interrupted. Thus, this parking situation exhibits similar features to a calamity situation of a power failure, whereupon the fail-safe mechanism would come into operation. By providing the blocking mechanism, the fail-safe mechanism will be blocked in such a parking situation and the shutoff elements can still be brought to a predefined position in a controlled manner with the aid of the drive unit and/or with the aid of an energy storage element. In the case of a parking situation, the predefined position can be the closed position or the open position or an intermediate position. Also, the predefined position may be different for different parts of shutoff elements and/or different for different sets of shutoff elements.

Advantageously, the energy can remain present in the fail-safe mechanism during its condition of being rendered temporarily inoperative. For instance, if the fail-safe mechanism comprises an energy storage element, the fail-safe mechanism can be rendered temporarily inoperative via the blocking mechanism whilst the energy in the energy storage element is at least partly preserved. In this way, the energy of the fail-safe mechanism is directly available again when the condition of being temporarily inoperative is undone. For instance, it may be that the fail-safe mechanism is provided with an arm, as well as with an energy storage element. A blocking mechanism can then render the fail-safe mechanism temporarily inoperative by temporarily blocking the operation of the arm. The energy in the energy storage element remains virtually and/or substantially untouched. When the temporary rendering inoperative is undone, for instance by unblocking the arm again, the energy from the energy storage element is directly available again for the fail-safe function. In another embodiment, for instance, a fail-safe mechanism provided with an energy storage element may be temporarily rendered inoperative by, for instance, counteracting the energy being released from the energy storage element. This could be done electrically or mechanically. The energy then remains available in the energy storage element, but the blocking mechanism can then temporarily prevent the energy from being released and thus the operation of the fail-safe mechanism is temporarily blocked. Conversely, when blocking is undone, the fail-safe function is directly available again.

In an alternative embodiment, in rendering the fail-safe mechanism temporarily inoperative, the energy can be released from the energy storage element. When the rendering inoperative of the fail-safe mechanism is subsequently undone, first energy needs to be stored in the energy storage element before functional operation of the fail-safe mechanism is available, when the fail-safe mechanism is provided with an energy storage element.

Another predetermined situation, which is not a calamity situation, is, for instance, a start-stop situation that can occur with a motor vehicle, for instance, when waiting before a traffic light. In such a start-stop situation the current supply may, for instance, be limited to a few functions of the motor vehicle, while the current supply to the adjusting instrument can be interrupted.

According to an aspect of the invention, the blocking mechanism is activatable by a predetermined input signal. By providing the adjustment device with a predetermined input signal, it is clear beforehand when a blocking situation occurs and when the blocking mechanism is to be activated accordingly. By providing a predetermined input signal, the fail-safe mechanism's coming into operation can be obviated.

There are, in short, at least three possible situations that may give rise to activation of the adjustment device. These are an operating situation, a calamity situation, and a blocking situation. The operating situation is the usual operational situation of the adjustment device, in which the drive unit can adjust the shutoff elements between the open position and the closed position and a random position in-between, in response to a received operational input signal. The operational input signal is usually passed on via the board network of the motor vehicle to the adjustment device. This can be done, for instance, via a LIN system.

The calamity situation or fail-safe situation is the situation in which a calamity occurs and the fail-safe mechanism comes into operation accordingly. The calamity situation may or may not be announced by an input signal. For instance, a calamity input signal may be generated in the event of detection of too high a temperature in the motor compartment and/or the air inlet, as in case of fire, but in the case of power failure probably no input signal will be generated.

The blocking situation is the situation which exhibits features of a calamity situation, for instance the interruption of power, but in which the fail-safe mechanism does not come into operation. The blocking situation is preferably announced through a predetermined input signal which, preferably via the onboard network, for instance LIN, is passed on to the adjustment device. Via such a predetermined input signal, which we will also refer to as blocking signal hereinafter, the blocking mechanism is activated so as to temporarily deactivate the operation of the fail-safe mechanism.

In a preferred embodiment, the predetermined input signal is supplied to the adjustment device before the blocking situation occurs. The adjustment device is thus informed in advance that a blocking situation is about to occur. Due to the time difference between the blocking signal and the blocking situation, there can be sufficient time to adjust the adjustment device to a predefined blocking position with the aid of the drive unit which can still be provided with power during the time difference. For instance in the case of a parking situation, upon stopping the driving motor of the motor vehicle, a circuit of the onboard network of the motor vehicle is still provided with power for a particular time before it is de-energized. In addition, the onboard network can comprise another circuit which continues to be provided with voltage. The adjustment device according to the invention is connected with the circuit which is eventually de-energized after the switch off of the driving motor of the motor vehicle. By making use of the time difference between transmission of the input signal and the actual blocking situation, in a favorable manner use can still be made of the current supply still available. Alternatively, if, for instance, the blocking signal is transmitted concurrently with the occurrence of the blocking situation, use can be made, for instance, of an energy storage element, such as, for instance, a battery or capacitor, to bring the adjustment device to the predetermined blocking position. Such an energy storage element may be situated near the drive unit and/or near the shutoff elements and/or elsewhere in the vehicle. The energy storage element may be coupled directly with the shutoff elements and/or with the drive unit, and/or engage an intermediate mechanism. Many variants are possible.

In an operating situation it may be that the shutoff elements are in the closed position. In case of a blocking situation the shutoff elements will then remain in the closed position and the blocking mechanism will block the operation of the fail-safe mechanism. If in the operating situation the shutoff elements are in an open position or in an intermediate position, then the shutoff elements can be adjusted to the predefined blocking position, corresponding, for instance, to the closed position, upon receipt of the blocking signal. The blocking mechanism can then block the operation of the fail-safe mechanism.

Advantageously, the blocking mechanism comprises a blocking element which is adjustable between a first position, in which the fail-safe mechanism is free, and a second position, in which the fail-safe mechanism is blocked. Owing to the blocking element being adjustable, the fail-safe mechanism may or may not be blocked, depending on the input signal.

Advantageously, the blocking element is arranged for fixing at least a part of the fail-safe mechanism and/or for fixing at least a part of the drive train. The fail-safe mechanism can be designed, for instance, as described in WO 2012/067502, for instance, comprising a biased spring as energy storage element, which, through an arm, is held biased by an activation element. The spring is connected on one side with a housing of the adjustment device and on the other side with a drive wheel of the drive unit. In the case of a calamity, the activation element activates the arm, thereby causing the arm to pivot. Through the pivoting of the arm, the energy in the energy storage element is released, for instance in that the spring as energy storage element is released. Owing to the release of the energy of the energy storage element, for instance a drive wheel of the drive unit can be moved to bring the shutoff elements to the predefined calamity position.

The blocking element can now be so designed that it, for instance, blocks the arm of the fail-safe mechanism in predetermined blocking situations. The arm is then, for instance, fixed, so that it is not movable, even if the activation element were to activate. The fail-safe mechanism is then blocked at least temporarily.

The blocking element, however, may also be so designed that a component of the drive unit, in particular a component of the drive train, for instance, a drive wheel, is fixed in a predetermined blocking situation. For instance, the blocking element, after a predetermined blocking input signal has been received, can guide the drive wheel still further to the blocking position in a controlled manner, for instance via a pin/groove connection in the drive wheel.

The invention further relates to a method for blocking a fail-safe mechanism.

The invention furthermore relates to an air inlet of a motor vehicle provided with an adjustment device having a blocking mechanism, and to a motor vehicle provided with an air inlet with adjustment device with a blocking mechanism.

Further advantageous embodiments are set forth in the subclaims.

The invention will be further elucidated on the basis of exemplary embodiments which are represented in the drawing. In the drawing:

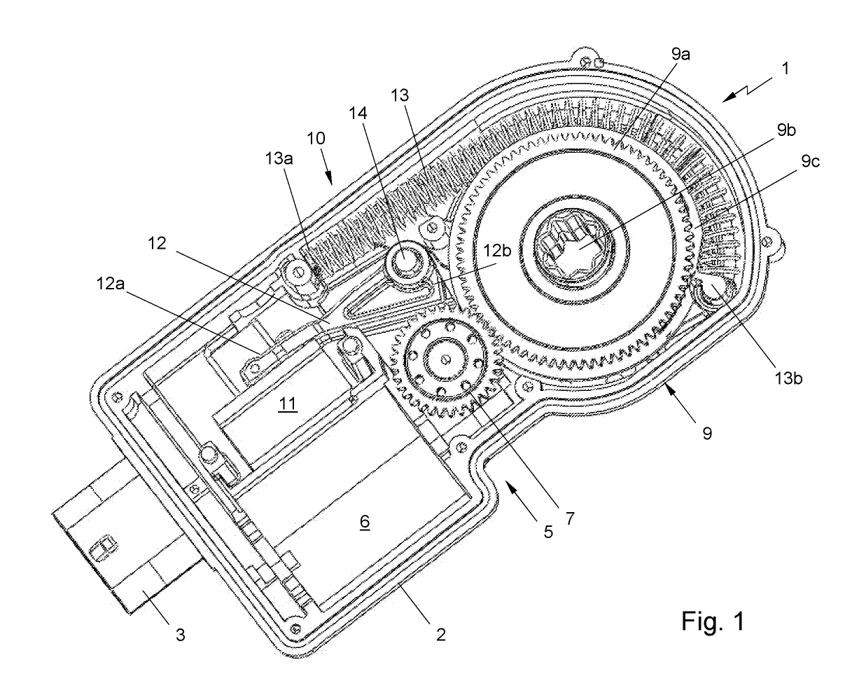

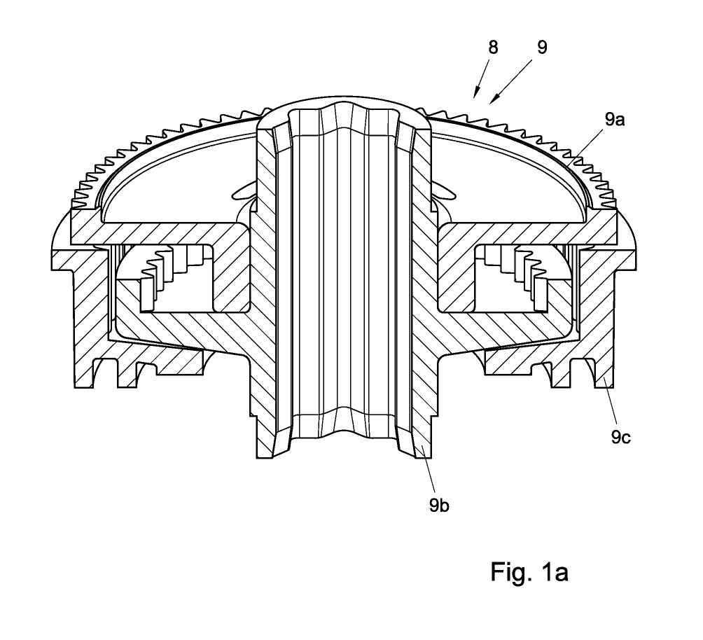

FIG. 1 shows a schematic perspective view of an adjustment device provided with a fail-safe mechanism;

FIG. 1a shows a schematic cross section of a drive train as used in the adjustment device of FIG. 1;

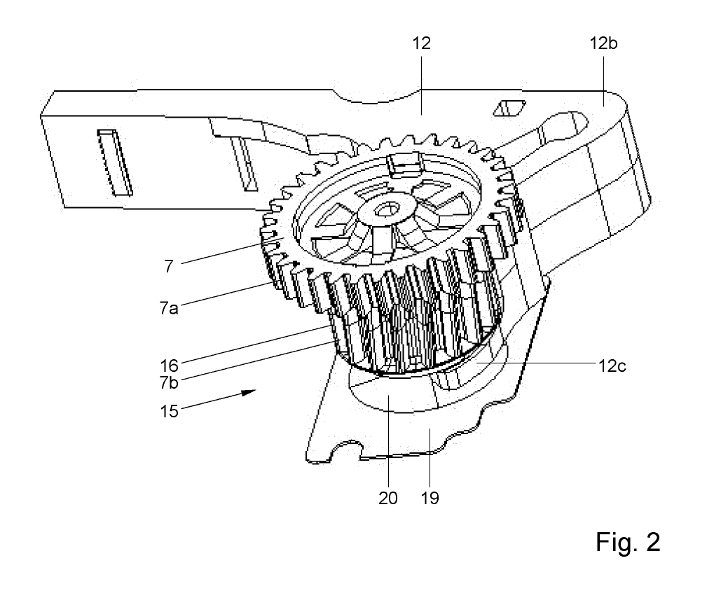

FIG. 2 shows a schematic perspective view of a first embodiment of a blocking mechanism according to the invention;

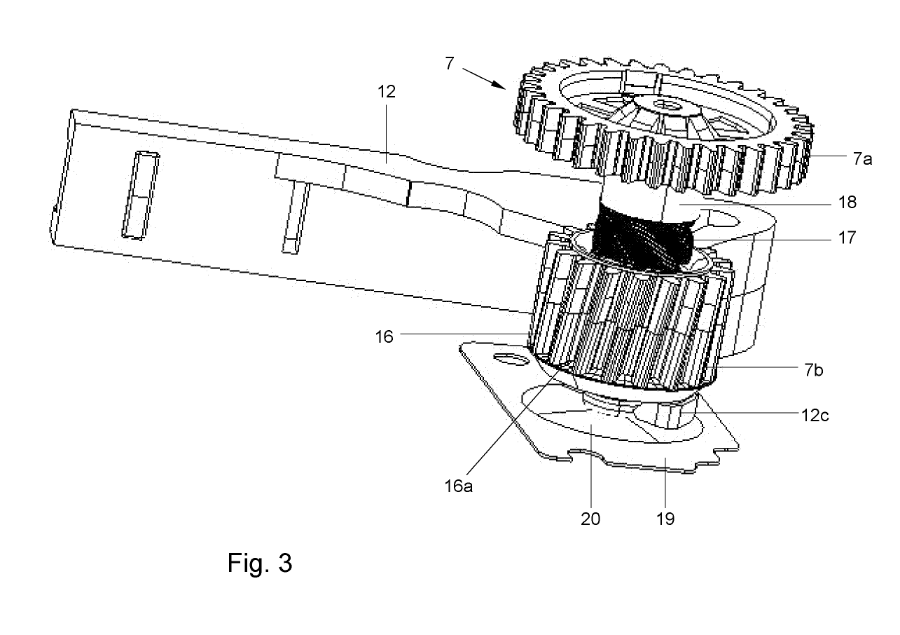

FIG. 3 shows a schematic perspective exploded view of the blocking mechanism of FIG. 2;

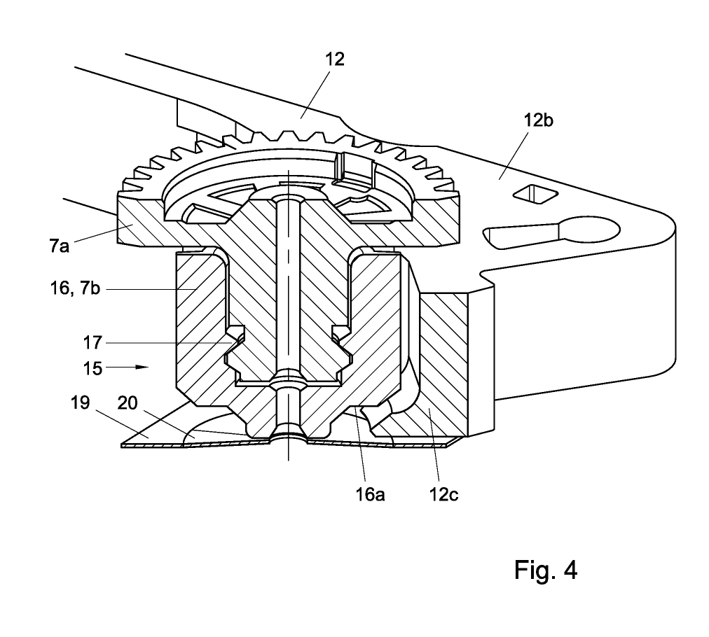

FIG. 4 shows a cross section of the blocking mechanism of FIG. 3 in the free position;

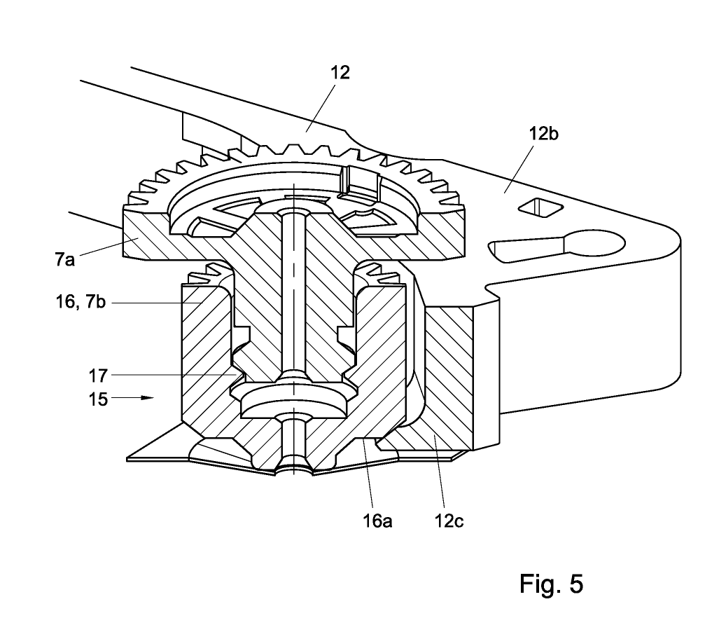

FIG. 5 shows a cross section of the blocking mechanism of FIG. 3 in the blocked position;

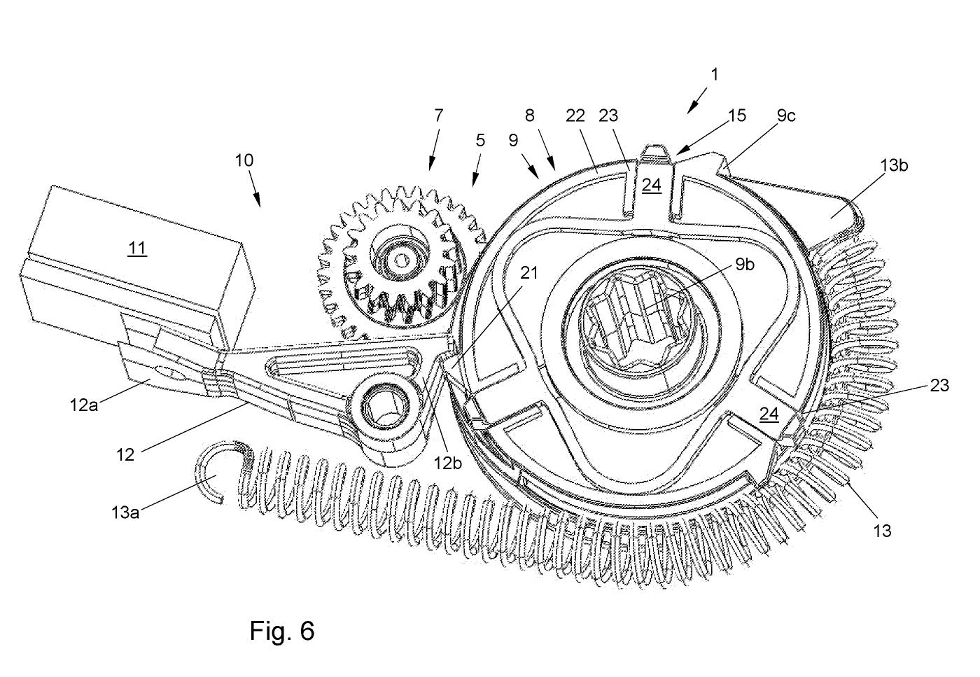

FIG. 6 shows a schematic perspective view of a second embodiment of a blocking mechanism according to the invention;

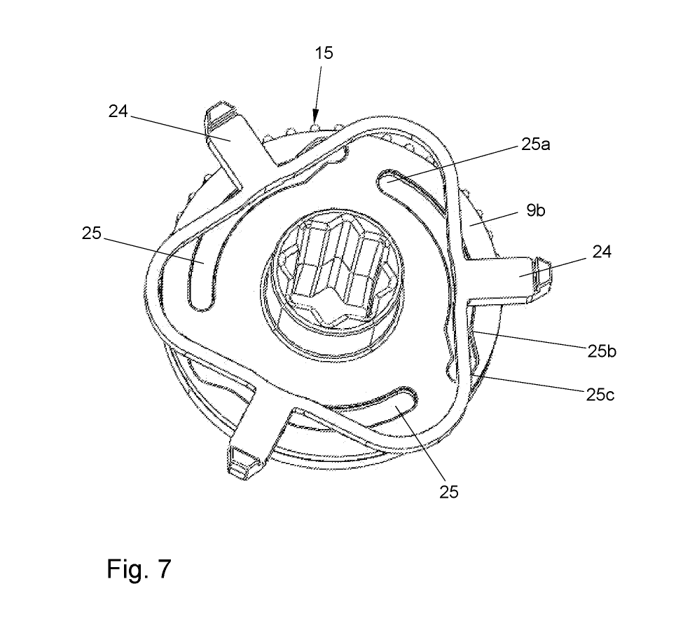

FIG. 7 shows a schematic perspective view of the blocking mechanism of FIG. 6;

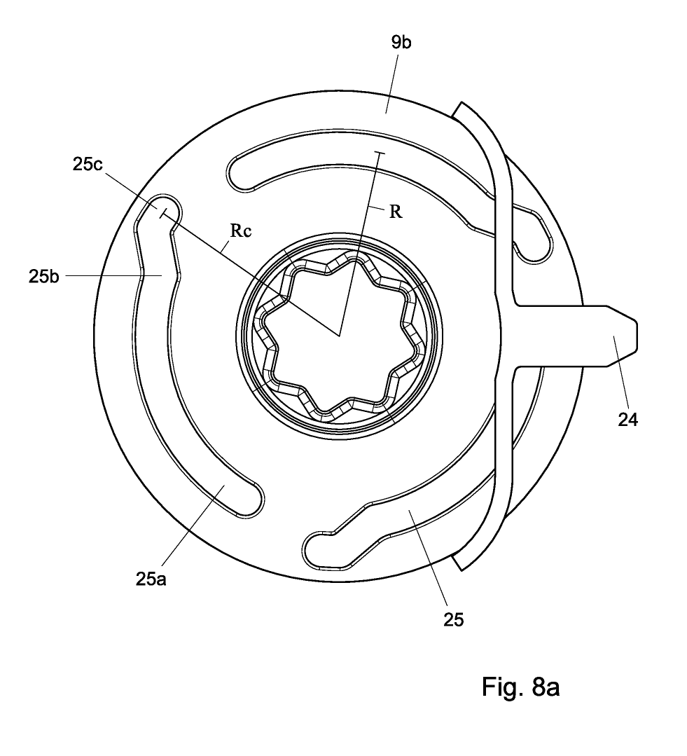

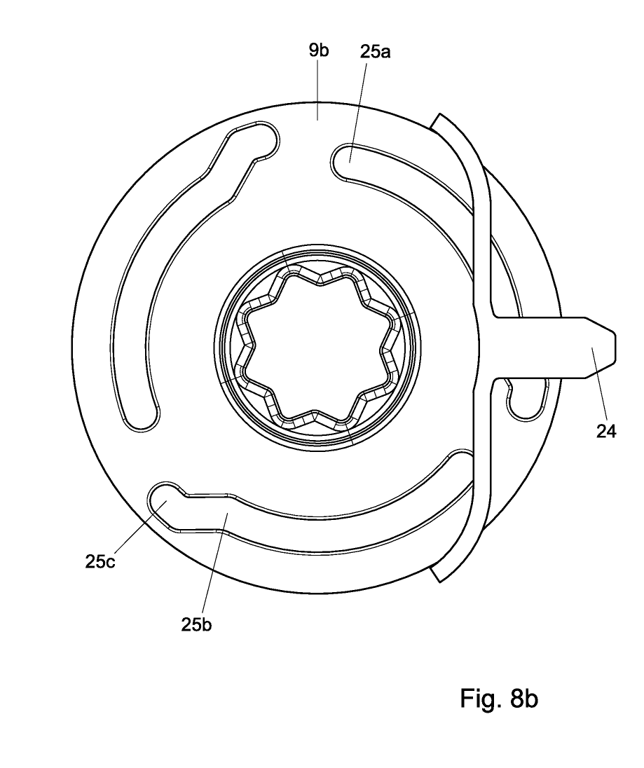

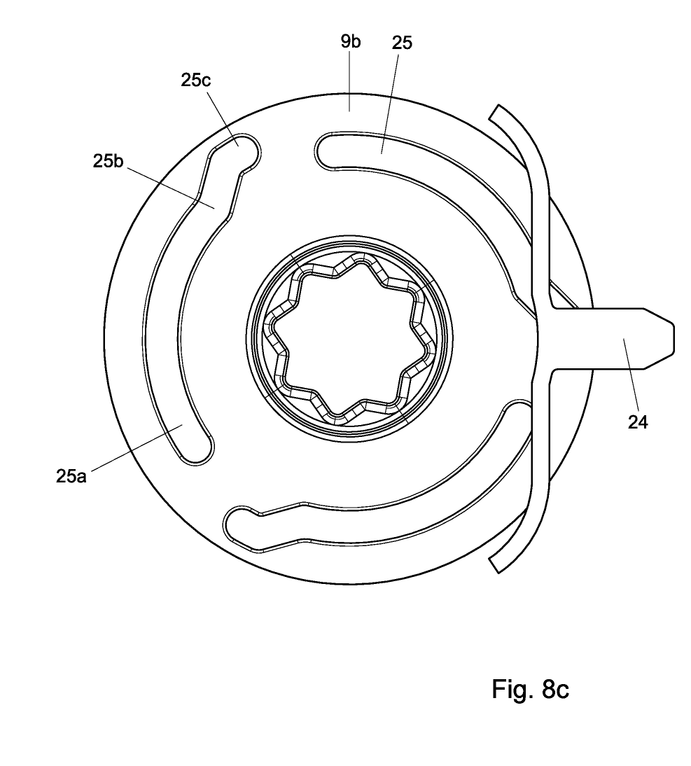

FIG. 8a, FIG. 8b, FIG. 8c show a schematic top plan view of a blocking mechanism according to FIG. 6 with a blocking pawl in positions a, b, and c, respectively; and

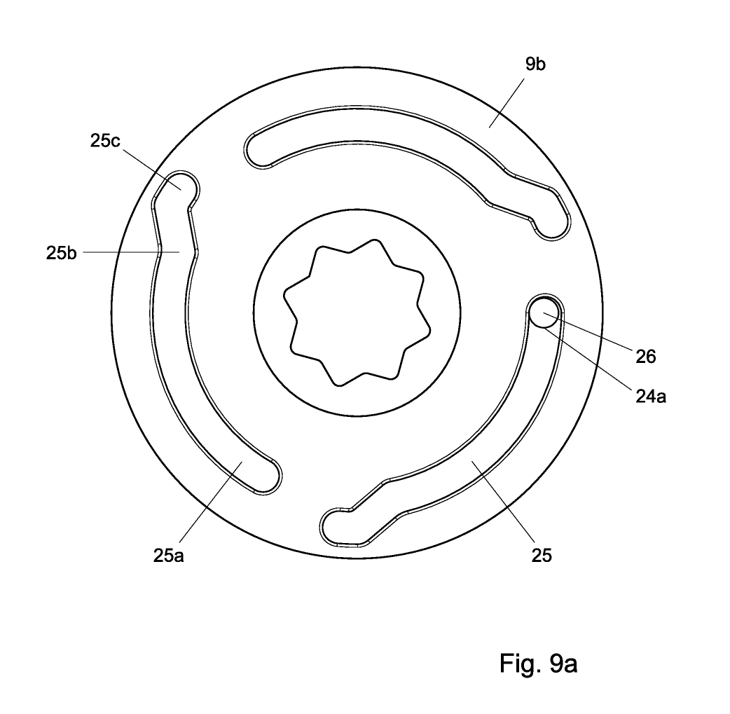

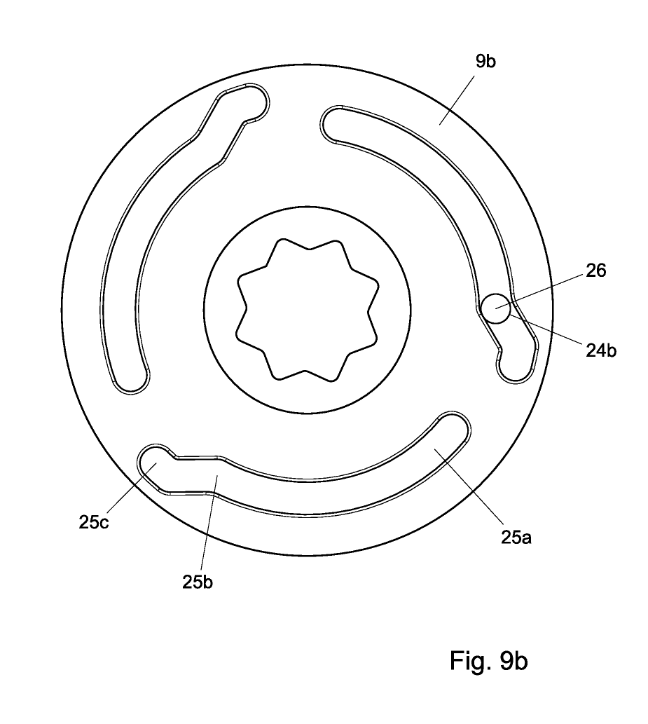

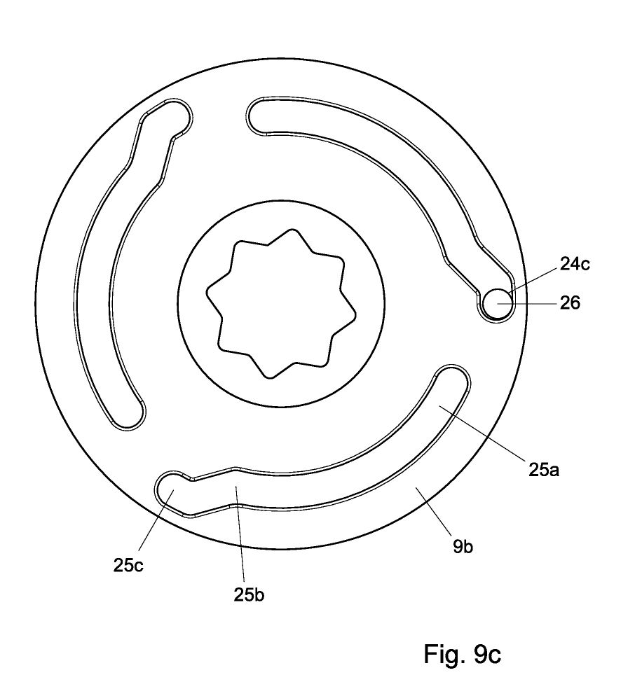

FIG. 9a, FIG. 9b, FIG. 9c show a schematic top plan view of a blocking mechanism according to FIG. 6 with a pin in positions a, b, and c, respectively.

It is noted that the figures are merely shown by way of schematic representations of exemplary embodiments of the invention and should not be regarded as limiting in any way. In the figures, like or corresponding parts are designated by like or corresponding reference numerals.

FIG. 1 shows a schematic perspective view of an adjustment device 1. The adjustment device 1 is usually provided in a housing 2. The housing 2 usually comprises two shell parts, in FIG. 1 one shell part is omitted to obtain a view of the interior of the adjustment device 1.

The adjustment device 1 is arranged for adjusting shutoff elements of an air inlet of a motor vehicle. These may be shutoff elements for, for instance, shutting off an air supply to the motor compartment, for instance, the air inlet above and/or under a bumper of the motor vehicle. The shutoff elements may also be situated, for instance, in an air supply to the air conditioning unit. The shutoff elements can be, for instance, strips which are pivotable about a standing or a lying axis or form a flower-shaped strip pattern, or can be, for instance, a roller curtain. Many variants are possible.

The adjustment device 1 is provided with electric power and/or input signals via a connector 3. The input signals can be supplied to the adjustment device 1, for instance, via the onboard network, for instance via LIN, or via another adjustment device. The adjustment device 1 is furthermore provided with an output shaft which is arranged for driving the shutoff elements.

The adjustment device 1 comprises furthermore a drive unit 5. The drive unit 5 comprises a motor 6 and a drive train 8. The drive train 8 is driven by the motor 6. The drive train 8 comprises an intermediate gear 7 and, in this exemplary embodiment, a compound planetary gear system 9.

The drive unit 5 and the drive train 8 are not further elaborated in the context of this application.

The motor 6 can be, for instance, an electric actuator which can be provided with power and/or input signals via the connector 3.

The adjustment device 1 is furthermore designed with a fail-safe mechanism 10.

The fail-safe mechanism 10 comprises in this exemplary embodiment an activation element 11, a lever arm 12 and an energy storage element 13. The activation element 11 is here designed as a magnetic element 11 which, when live, pulls an end 12a of the lever arm 12 towards it. An end 12b hooks behind a cam of a drive wheel of the drive unit 5, in particular of the planetary gear system 9.

The compound planetary gear system 9 consists of an input shaft 9a and two output shafts 9b and 9c. The input shaft is formed by the sun gear 9a, which is drivable by the motor 6 via the intermediate gear 7. A first output shaft 9b forms the output shaft for adjusting the shutoff elements. The second output shaft 9c is formed by a ring gear 9c of the planetary gear system 9. The ring gear as second output shaft 9c can be, for instance, under the action of the spring 13. The ring gear 9c is, for instance, provided with the cam behind which the end 12b of the lever arm 12 can hook. The compound planetary gear system may be, for instance, of the ‘Harmonic Drive’ type, well known to those skilled in the art.

An end 13a of the energy storage element 13, here implemented as a spring 13, is connected with the housing 2 as being the fixed world. Another end 13b is connected with a part of the drive train 8, for instance the ring gear as second output shaft 9c. As the spring 13 is biased, energy is stored in the spring, which is released if an end of the spring 13 is released.

In case of a calamity situation, the activation element 11 will be activated, this may be done, for instance, through interruption of the current supply to the magnetic element 11. Upon the current supply dropping out, the end 12a uncouples from the magnetic element 11, and the lever arm 12 will pivot about pivot 14, so that end 12b releases the cam (not shown) of the ring gear 9c. As a result, the planetary gear system 9 will pivot under the influence of the energy stored in the spring 13 to a predefined position, the calamity position. For instance, the predefined calamity position can be the closed position of the shutoff elements.

According to the invention, the adjustment device 1 is provided with a blocking mechanism 15, not visible in FIG. 1, but shown, for instance, in FIG. 2, FIG. 3, or FIG. 4, FIG. 5. The blocking mechanism 15 is arranged for blocking the fail-safe mechanism 10 in predetermined situations, so-called blocking situations. For instance in a parking situation, when the motor of the motor vehicle is switched off and there is no current supply to the adjustment device 1 anymore, it is not desirable that the fail-safe mechanism 10 be activated.

In the exemplary embodiment of FIG. 2 and FIG. 3, the blocking mechanism 15 comprises a blocking element 16 which is adjustable between a first position, in which the fail-safe mechanism 10 is left free, and a second position, in which the fail-safe mechanism 10 is blocked. The blocking element 16 is here a component of the drive unit 5, more particularly of the intermediate gear 7. The blocking element 16 is here the gear 7b which is driven by the motor 6 via a worm wheel (not shown).

The intermediate gear 7 is designed as two mutually adjustable parts, as shown in FIG. 3. The intermediate gear 7 comprises an upper gear 7a and a lower gear 7b. The lower gear 7b is drivable by the motor 6, and via a coupling with the upper gear 7a the driving force is transmitted to the sun gear 9a of the planetary gear system 9. The lower gear 7b functions as blocking element 16. In this exemplary embodiment, lower gear 7b and blocking element 16 constitute the same component of the drive unit 5.

As is shown in FIG. 3, the upper gear 7a and the blocking element 16 are mutually adjustably connected through coupling means 17. The coupling means 17 are here implemented as a screw thread, for instance, an inner side of the blocking element 16 is provided with an inner thread, and a shaft part 18 is provided with a complementary thread for cooperation with the inner thread of the blocking element 16. Via the thread, the upper gear 7a and the blocking element 16 are adjustable relative to each other in translation and rotation. Obviously, other coupling means are possible, such as a pin/groove, etc.

The lever arm 12 is provided at its end 12b with a finger 12c. The finger 12c is so shaped as to be able to cooperate with an underside 16a of the blocking element 16. When the fail-safe mechanism 10 is not activated, the finger 12c is situated as shown in FIG. 4 and FIG. 5.

Due to the coupling means 17, the lower gear 7b, functioning as blocking element 16, is adjustable between a first position and a second position. In the first position the blocking element 16 is upwards, shown in FIG. 4, and the finger 12c is free. The fail-safe mechanism 10 is thus free and upon activation the arm 12 can pivot.

In the second position the blocking element 16 is downwards, as shown in FIG. 5, and the underside 16a is supported on the upper side of the finger 12c to block the finger 12c. The finger 12c is then clamped between the underside 16a of the blocking element 16 and a spring element 19. The spring element 19 is here implemented as a substantially planar plate-shaped element which can be part of the housing 2, or can be mounted against the housing 2. In this exemplary embodiment, the spring element 19 is also provided with segment parts 20. The segment parts 20 provide that the spring element 19 forms a so-called buckling spring.

What is achieved with the spring element 19 is that during normal adjustment in the operating situation the blocking element 16 remains in the upward first position, and hence the adjustment device remains in the fail-safe mode. The spring element 19 pushes the blocking element 16 upwards to the first position. In the case of a blocking situation the blocking element 16 adjusts downwards against the force of the spring element 19.

In the case of a blocking situation the adjustment device 1 receives a predetermined input signal, a so-called blocking signal. In the case of a blocking signal, the blocking mechanism 15 comes into operation.

The motor 6 drives the lower gear 7b which, coupled to upper gear 7a, drives the planetary gear system 9, so that the shutoff elements are adjusted. Upon reaching the end of the adjustment stroke, for instance when the shutoff elements are in the open or the closed position, the chive train 8 stops moving. However, since the motor 6 further drives the lower gear 7b, the lower gear 7b will adjust relative to the upper gear 7a against the force of the spring element 19, along the path dictated by the coupling means 17, here the thread 17. The lower gear 7b, being the blocking element 16, is therefore adjusted downwards to the second position until the underside 16a abuts against the upper side of the finger 12c. The motor 6 drives the lower gear 7b, functioning as blocking element 16, further downwards against the force of the spring element 19, so that a firm clamping of the finger 12c can be achieved. Upon reaching a sufficiently firm clamping of the finger 12c, the motor 6 will cut out, for instance when the current of the motor 6 runs up exceeding a predetermined upper limit. The finger 12c is then blocked and so is the fail-safe mechanism 10, while the shutoff elements are in a predetermined blocking position.

In a possible embodiment, the end position, for instance the open or the closed position of the shutoff elements, can be detected by an increase of the current level. When the current level of the motor 6 increases beyond a particular upper limit, it can be concluded that the shutoff elements are at the end of their adjustment stroke. To take the tension out of the system then, the motor 6 may be driven in the opposite direction to adjust, for instance, a drive wheel of the drive unit reversely by a number of degrees, for instance 5 degrees. The shutoff elements are then still in the open or closed end position, but the tension in the system is reduced.

In the case where the adjustment device is provided with a blocking mechanism according to the invention, in an advantageous manner use can be made of this small additional reverse angular displacement. For instance, if in the example of FIG. 2, FIG. 3, FIG. 4 or FIG. 5 the shutoff elements are in an open or closed end position, then, after reception of a blocking signal, the motor 6 will not be rotated back, but the lower gear 7b functioning as blocking element 16 will adjust downwards until the finger 12c is clamped.

Preferably, the spring element 19 is implemented in a bistable design, viz., in the form of a buckling-loadable spring leaf provided with segment parts 20. In that case, the spring element 19, in particular the segment parts 20, will buckle when the blocking element 16 exceeds the buckling force. In this way, the load at which the fail-safe mechanism 10 is blocked is uniformly determined. In a preferred embodiment, the spring element 19 then consists of a flat plate designed in spring steel, with a forced spherical part comprising segment parts 20.

For undoing the blocking position, through a reverse drive of the motor 6 the blocking element 16 can be moved upwards again to the first position, so that the finger 12c is cleared and the operation of the fail-safe mechanism 10 is unblocked.

An alternative embodiment is shown in FIG. 6, FIG. 7, FIG. 8, and FIG. 9.

FIG. 6 shows a schematic perspective view of an adjustment device 1. Depicted in FIG. 6 are the fail-safe mechanism 10, as well as a part of the drive unit 5, the intermediate gear 7 and the planetary gear system 9. The fail-safe mechanism 10 comprises an activation element 11, implemented as a magnetic element, and a lever arm 12. End 12b of the lever arm 12 hooks behind a cam of, here, the output shaft 9c of planetary gear system 9, for instance a ring gear 9c. The energy storage element 13, here a biased spring, is connected on one side by end 13a to the housing as fixed world (not shown) and connected on the other side by end 13b to output shaft 9c of the planetary gear system 9. The fail-safe mechanism 10 works in a comparable manner to the fail-safe mechanism shown in FIGS. 1-5.

In order to block the operation of the fail-safe mechanism 10 in predetermined blocking situations, the adjustment device 1 is provided with a blocking mechanism 15. The blocking mechanism 15 comprises in this exemplary embodiment a wheel 22 provided with at least one slot 23 in which a blocking pawl 24 is slidable. Wheel 22, in a preferred design, will coincide with and/or be rotation-locked with respect to the spring-biased ring gear 9c as second output shaft 9c of the planetary gear system 9. The blocking pawl 24 is furthermore provided with a pin 26 (not visible) which moves in a groove 25 of, preferably, the output driving wheel as first output shaft 9b of the planetary gear system 9. During adjustment of the shutoff elements, in the operational position of the adjustment device 1, the pin 26 moves back and forth in the groove 25 between the desired positions. The groove 25 has a first extreme position 25a and an intermediate position 25b, within which are the operating positions of the pin 26 and hence of the blocking pawl 24. These correspond to the operating situation of the adjustment device 1. These correspond also to the operating positions of the shutoff elements. Between the first extreme position 25a and the intermediate position 25b, the groove 25 has the shape of a segment of a circle, having a substantially constant radius R relative to the center of wheel 9b. As a result, through a suitable cooperation between pin 26 and groove 25, the blocking pawl 24 is within a contour of wheel 9c. As a result, wheel 9c can freely rotate under the action of spring 13 in case of a fail-safe situation. Between the intermediate position 25b and extreme position 25c, the groove 25 has the shape of a spiral, with increasing radius up to radius Rc between positions 25b and 25c. As a result, through a suitable cooperation between pin 26 and groove 25, in the second extreme position 25c blocking pawl 24 is outside the contour of wheel 9c and then cooperates with a corresponding recess in at least one of the two shell parts of the housing 2. Wheel 9c is thereby rotation-locked with respect to the housing, and the operation of the fail-safe mechanism is thereby blocked.

FIGS. 8a and 8b show the blocking pawl 24 within a contour of a non-depicted wheel 9c in the positions 25a, 25b of the groove 25 with the pin 26 of the blocking pawl 24 in the corresponding positions 24a, 24b of the groove 25, as shown in FIGS. 9a and 9b. These are the operating positions corresponding to the operating situation of the adjustment device 1. In FIG. 8a and FIG. 9a the blocking pawl 24 and the pin 26 are respectively in position 24a adjacent end 25a of the groove 25. In FIG. 8b and FIG. 9b the blocking pawl 24 and the pin 26 are respectively in position 24b adjacent intermediate position 25b of the groove 25. In FIG. 8c and FIG. 9c the blocking pawl 24 and the pin 26 are respectively in extreme position 24c adjacent end 25c of the groove 25. As position 25c is on a greater radius Rc than positions 25a and 25b on radius R, the blocking pawl 24 is guided outwards into the slot 23 of wheel 22 which is correspondingly positioned.

When a predetermined input signal, the so-called blocking signal, has been received, the drive unit 5, in particular the motor 6, can be controlled to rotate the drive train 8 still further so that the pin 26 of the blocking pawl 24 is guided from position 25b to position 25c, so that the blocking pawl 24 moves outwards and rotation-locks the drive train 8 relative to the housing 2, in particular, fixes wheel 9c relative to the housing 2, so that the operation of the fail-safe mechanism 10 is blocked. When, advantageously, the blocking signal is received a particular time before the occurrence of the blocking situation, use can still be made of the current present to rotate the drive train 8 further. Alternatively, use can be made of an energy storage element to block the operation of the fail-safe mechanism and to bring the shutoff elements to a predefined blocking position.

Through a favorable control of the motor 6 and/or by making use of position sensors, it can be ensured that in a normal use position of the driving wheel 9b, corresponding to output shaft 9b, pin 26 is within positions 25a and 25b of groove 25, and between positions 24a and 24b of the pin 26, as shown in FIGS. 9. The adjustment device 1 is thus in the fail-safe mode in which the fail-safe mechanism 10 can be activated and can come into operation. Moreover, if desired, for instance when parking the motor vehicle, the operation of the fail-safe mechanism 10 can be blocked by means of one or more blocking pawls 24, in that pin 26 is directed to position 25c of groove 25.

It will be understood that the output shafts of a compound planetary gear system can be interchanged, so that, for instance, the ring gear forms the first output shaft and a drive wheel the second output shaft. Also, the slots or grooves associated with the output shafts can be interchanged, or be designed differently.

The invention is not limited to the exemplary embodiments represented above. Many variants are possible and will be clear to the skilled person. In the above-mentioned examples, the blocking mechanisms are represented as mechanical blocking mechanisms, but diverse variants of mechanical blocking mechanisms are possible and can either fix a part of the fail-safe mechanism or fix a part of the drive unit to thereby block the operation of the fail-safe mechanism. Such variants are understood to fall within the scope of the appended claims.

### LIST OF PARTS

1. adjustment device
2. housing
3. connector
4. [not in use]
5. drive unit
6. motor
7. intermediate gear
7a. upper gear
7b. lower gear
8. sun gear
9. drive train/compound planetary gear system
9a. input shaft/sun gear
9b. first output shaft
9c. second output shaft
10. fail-safe mechanism
11. activation element/magnetic element
12. lever arm
12a. end of lever arm
12b. end of lever arm
12c. finger
13. energy storage element/spring
13a. end of spring
13b. end of spring
14. pivot
15. blocking mechanism
16. blocking element
17. coupling means
18. shaft part
19. spring element
20. segment parts
21. cam
22. wheel
23. slot
24. blocking pawl
24a, 24b, 24c positions of pin 26
25. groove
25a, 25b, 25c positions in groove 25
26. pin
R radius of positions 25a, 25b
Rc radius of position 25c

1. An adjustment device for adjusting shutoff elements of an air inlet of a motor vehicle, wherein the shutoff elements are adjustable between an open position in which the air inlet is substantially open and a closed position in which the air inlet is substantially closed, comprising a drive unit for adjusting the shutoff elements between at least the open position and the closed position, furthermore comprising a fail-safe mechanism which is arranged for adjusting the air inlet to a predefined position in case of a calamity situation, wherein the adjustment device furthermore comprises a blocking mechanism for blocking the operation of the fail-safe mechanism in predetermined situations, wherein in such predetermined situations the shutoff elements are adjustable to a predefined position without activation of the fail-safe mechanism.

2. The adjustment device according to claim 1, wherein the blocking mechanism is activatable by a predetermined input signal.

3. The adjustment device according to claim 1, wherein
the blocking mechanism comprises a blocking element which is adjustable between a first position in which the fail-safe mechanism is free and a second position in which the operation of the fail-safe mechanism is blocked.

4. The adjustment device according to claim 3, wherein the blocking element is arranged as part of the drive unit.

5. The adjustment device according to claim 3, wherein
the blocking element is arranged for fixing at least one of at least a part of the fail-safe mechanism or of at least a part of the drive train.

6. The adjustment device according to claim 5, wherein the blocking element is arranged for blocking a lever arm of the fail-safe mechanism.

7. A method for blocking the operation of a fail-safe mechanism, comprising providing an adjustment device provided with a blocking mechanism according claim 1, and supplying a predetermined input signal which announces a blocking situation.

8. A motor vehicle provided with an adjustment device according to claim 1.
